(19) United States
(12) Patent Application Publication
(10) Pub. No.: US 2017/0120280 A1
(43) Pub. Date: May 4, 2017

(54) FLOWRATE MEASURING TYPE VISCOUS LIQUID DISPENSER AND DISPENSING METHOD

(71) Applicant: PROTEC CO., LTD., Gyeonggi-do (KR)

(72) Inventor: Seung Min HONG, INCHEON (KR)

(73) Assignee: PROTEC CO., LTD., Gyeonggi-do (KR)

(21) Appl. No.: 15/336,817

(22) Filed: Oct. 28, 2016

(30) Foreign Application Priority Data
Oct. 30, 2015 (KR) 10-2015-0152480

(51) Int. Cl. B05B 12/08; G01F 1/684; G01F 11/00; B05B 9/00; B05B 9/04

(52) U.S. Cl. CPC B05B 12/085; B05B 9/002; B05B 9/0403; G01F 11/006; G01F 1/684

(57) ABSTRACT

Provided are a flowrate measuring type viscous liquid dispenser and dispensing method, in which a viscous liquid is dispensed by measuring a flowrate of the viscous liquid in real time so as to accurately control the flowrate of the viscous liquid.

### CROSS-REFERENCE TO RELATED APPLICATION

This application claims the benefit of Korean Patent Application No. 10-2015-0152480, filed on Oct. 30, 2015, in the Korean Intellectual Property Office, the disclosure of which is incorporated herein in its entirety by reference.

### BACKGROUND

1. Field

One or more exemplary embodiments relate to a flowrate measuring type viscous liquid dispenser and dispensing method, and more particularly, to a flowrate measuring type viscous liquid dispenser and dispensing method, in which a flowrate of a viscous liquid to be dispensed may be accurately controlled by measuring the flowrate of the viscous liquid in real time.

2. Description of the Related Art

In semiconductor processes or light-emitting diode (LED) manufacturing processes, dispensers for coating a viscous liquid are widely used.

In such dispensers, accurate adjustment of an amount of a viscous liquid to be coated has a great impact on the process quality. In particular, a viscous liquid such as silicon or epoxy has a viscosity that sensitively varies according to a temperature. Silicon, for example, has a viscosity that varies over time when it is mixed with a hardening agent during dispensing. As described above, due to various reasons such as a variation of the characteristics of the viscous liquid, a dispensing amount may be varied during a dispensing operation.

According to the related art, a calibration method perfon ied using a scale is frequently used in order to maintain a uniform dispensing amount. A weight of dispensed viscous liquid is experimentally measured using a scale to check a dispensing condition of the viscous liquid using the dispenser, and a flowrate of the viscous liquid is adjusted by adjusting factors that may change the flowrate of the viscous liquid to resume the dispensing operation. However, in this method, the flowrate of the liquid is measured only experimentally, and the flowrate of the dispensed liquid or a change in the flowrate of the dispensed liquid is not known during an actual dispensing process. For example, even if a factor that causes a change in the flowrate is generated during the dispensing operation, the dispensing operation may be continued without finding the factor, and in this case, a large amount of defective products may be generated.

### SUMMARY

One or more exemplary embodiments include a flowrate measuring type viscous liquid dispenser and dispensing method, in which a viscous liquid may be dispensed by adjusting an amount of the viscous liquid to be dispensed by receiving a flowrate of the viscous liquid that is actually dispensed during a dispensing operation.

Additional aspects will be set forth in part in the description which follows and, in part, will be apparent from the description, or may be learned by practice of the presented embodiments.

According to one or more exemplary embodiments, a flowrate measuring type viscous liquid dispenser includes: a syringe for storing a viscous liquid to be dispensed; a pump module comprising a nozzle and dispensing the viscous liquid through the nozzle by receiving the viscous liquid from the syringe; a flowrate sensor module mounted in a flow path connecting the nozzle of the pump module and the syringe and configured to measure a flowrate of the viscous liquid; and a controller configured to receive the flowrate of the viscous liquid measured using the flowrate sensor module and generate a control signal for controlling an operation of the pump module.

According to one or more exemplary embodiments, a flowrate measuring type viscous liquid dispensing method includes: (a) operating a pump module to dispense a viscous liquid stored in a syringe, through a nozzle of the pump module; (b) measuring a flowrate of the viscous liquid transferred from the syringe to the nozzle, by using a flowrate sensor module mounted in a path connecting the syringe and the nozzle; and (c) increasing or reducing an amount of the viscous liquid dispensed through the nozzle of the pump module based on the flowrate of the viscous liquid measured in (b).

### BRIEF DESCRIPTION OF THE DRAWINGS

These and/or other aspects will become apparent and more readily appreciated from the following description of the embodiments, taken in conjunction with the accompanying drawings in which:

FIG. 1 is a schematic view of a flowrate measuring type viscous liquid dispenser according to an embodiment of the present invention; and

FIG. 2 is a schematic view of a flowrate measuring type viscous liquid dispenser according to another embodiment of the present invention.

### DETAILED DESCRIPTION

A flowrate measuring type viscous liquid dispenser and dispensing method according to the present invention will now be described more fully with reference to the accompanying drawings.

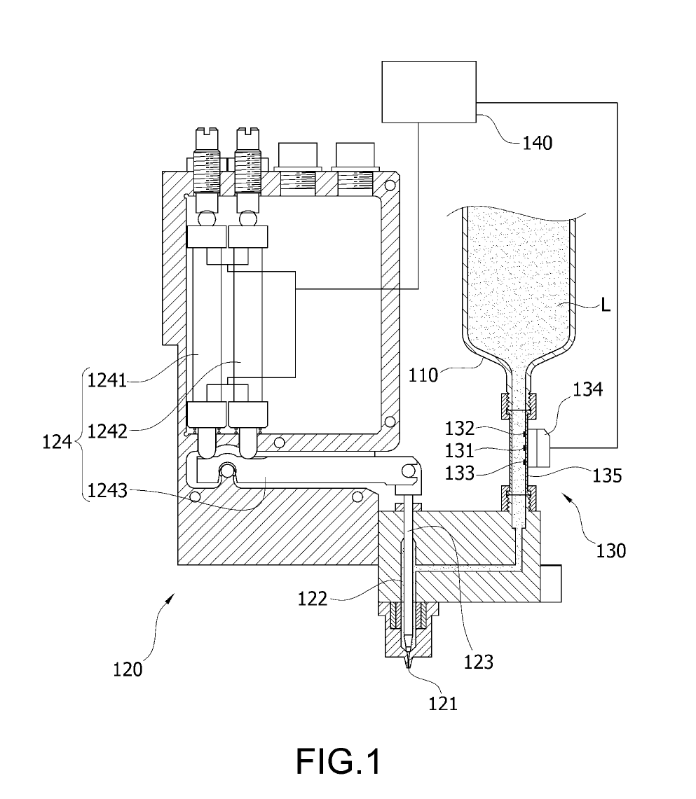

Referring to FIG. 1, the flowrate measuring type viscous liquid dispenser of the present embodiment may include a syringe 110, a pump module 120, a flowrate sensor module 130, and a controller 140.

The syringe 110 stores a viscous liquid L to be dispensed. A pressure is applied to the syringe 110 so as to easily supply the viscous liquid L stored in the syringe 110 to the pump module 120.

The pump module 120 is connected to the syringe 110 to dispense the viscous liquid L through a nozzle 121. The pump module 120 may have various structures for dispensing the viscous liquid L. Examples of the pump module 120 include a piezoelectric pump, a screw pump, and a linear pump. According to the present embodiment, a piezoelectric pump having a structure as illustrated in FIG. 1 will be described as the pump module 120.

The pump module 120 according to the present embodiment may include the nozzle 121, a reservoir 122, a valve rod 123, and an updown unit 124. The reservoir 122 receives the viscous liquid L from the syringe 110 so that the viscous liquid L is ejected through the nozzle 121. The valve rod 123 is liftably inserted into the reservoir 122. The updown unit 124 moves up and down the valve rod 123 with respect to the reservoir 122 so that the viscous liquid L is ejected from the reservoir 122 through the nozzle 121 via the moment generated by movement of the valve rod 123.

The updown unit 124 according to the present embodiment includes two piezoelectric actuators 1241 and 1242 and a lever 1243. The piezoelectric actuators 1241 and 1242 are formed of piezoelectric elements contracting or expanding in length according to an input voltage. The lever 1243 is rotatably mounted as two ends of the lever 1243 are respectively connected to the piezoelectric actuators 1241 and 1242 and the valve rod 123. The two piezoelectric actuators 1241 and 1242 are disposed with a rotational axis of the lever 1243 therebetween. When the two piezoelectric actuators 1241 and 1242 alternately contract or expand, the lever 1243 reciprocally rotates within a predetermined angle range with respect to a rotational axis thereof. The valve rod 123 connected to one end of the lever 1243 is moved up and down via the reciprocal rotation of the lever 1243.

The flowrate sensor module 130 is mounted between the syringe 110 and the reservoir 122. The flowrate sensor module 130 measures a flowrate of the viscous liquid L flowing from the syringe 110 to the reservoir 122.

The flowrate sensor module 130 according to the present embodiment includes a measurement pipe 135, a heater 131, two temperature sensors 132 and 133, and a calculator 134. The measurement pipe 135 is a portion of a flow path connecting the syringe 110 and the reservoir 122. The measurement pipe 135 has a uniform inner diameter along a length direction. The heater 131 is mounted inside the measurement pipe 135 to heat the viscous liquid L in the measurement pipe 135. The two temperature sensors 132 and 133 are spaced apart from each other and arranged adjacent to the heater 131 in the measurement pipe 135. As illustrated in FIG. 1, the two temperature sensors 132 and 133 may preferably be disposed in upstream and downstream portions of the measurement pipe 135 respectively, with the heater 131 included therebetween. The calculator 134 may calculate a velocity of the viscous liquid L inside the measurement pipe 135 based on a difference in temperatures respectively measured using the temperature sensors 132 and 133. The flowrate of the viscous liquid L may be calculated based on the velocity of the viscous liquid L and the inner diameter of the measurement pipe 135. The number and positions of the temperature sensors 132 and 133 of the flowrate sensor module 130 may be modified in various manners.

The controller 140 controls an operation of the updown unit 124 to move up and down the valve rod 123 to thereby dispense the viscous liquid L through the nozzle 121. The controller 140 may adjust a moving up and down speed, a moving up and down range (stroke), and the number of times of moving up and down the valve rod 123 by controlling a voltage applied to the piezoelectric actuators 1241 and 1242. As the controller 140 controls the updown unit 124, a dispensing amount of the viscous liquid L according to the operation of the valve rod 123 may be adjusted. Meanwhile, the controller 140 receives an accurate flowrate of the viscous liquid L dispensed through the nozzle 121 from the flowrate sensor module 130. The controller 140 operates the updown unit 124 based on the flowrate value received from the flowrate sensor module 130 so as to maintain a uniform flowrate of the viscous liquid L dispensed through the nozzle 121 or increase or reduce the flowrate of the viscous liquid L.

Hereinafter, a flowrate measuring type viscous liquid dispensing method according to an embodiment of the present invention performed using the flowrate measuring type viscous liquid dispenser configured as described above will be described.

First, in step (a), the pump module 120 is operated to dispense the viscous liquid L stored in the syringe 110, through the nozzle 121 of the pump module 120. As described above, the controller 140 applies a voltage to the piezoelectric actuators 1241 and 1242 to move up and down the valve rod 123, thereby dispensing the viscous liquid L.

When the viscous liquid L is dispensed through the nozzle 121, an amount of viscous liquid L corresponding to the dispensed viscous liquid L is newly supplied from the syringe 110 to the pump module 120. Here, by using the flowrate sensor module 130 mounted in a flow path connecting the syringe 110 and the nozzle 121, a flowrate of the viscous liquid L transferred from the syringe 110 to the nozzle 121 is measured in step (b).

In detail, step (b) is performed in a following order.

The viscous liquid L is heated using the heater 131 mounted in the measurement pipe 135 in step (b-1). Consequently, a temperature difference is generated in the viscous liquid L depending on a relative position thereof with respect to the heater 131. In addition, a temperature change is generated in the viscous liquid L around the heater 131 according to a velocity of the flow of the viscous liquid L.

As described above, a temperature of the viscous liquid L is measured using the temperature sensors 132 and 133 mounted respectively above and below the heater 131 in step (b-2).

In step (b-3), a velocity of the flow of the viscous liquid L may be calculated by considering a difference in temperatures respectively measured by the two temperature sensors 132 and 133 and relative positions of the temperature sensors 132 and 133 with respect to the heater 131.

A flowrate of the viscous liquid L may be calculated based on the velocity of the viscous liquid L described above and a cross-section of the measurement pipe 135.

In step (c), the controller 140 adjusts the flowrate of the viscous liquid L dispensed through the nozzle 121 by receiving the flowrate of the viscous liquid L calculated as in the above-described process and changing the voltage applied to the piezoelectric actuators 1241 and 1242.

When dispensing a viscous liquid by using a pump, typically, the pump is moved to coat a work while maintaining a uniform flowrate of a viscous liquid dispensed through a nozzle. Here, even if the flowrate of the viscous liquid L varies due to various reasons such as a temperature change or a variation of a viscosity of the viscous liquid L inside the syringe 110, a change in the flowrate may be monitored using the flowrate sensor module 130 in real time so that the controller 140 may maintain a uniform flowrate of the viscous liquid L. In particular, even when a factor of changing the flowrate occurs during the dispensing process of the viscous liquid L, the factor may be immediately sensed to maintain the flowrate at a desired level. In addition, also when the flowrate of the viscous liquid has to be adjusted during the process, the controller 140 operates the pump module 120 while receiving the variation of the flowrate in real time, thereby accurately controlling the flowrate.

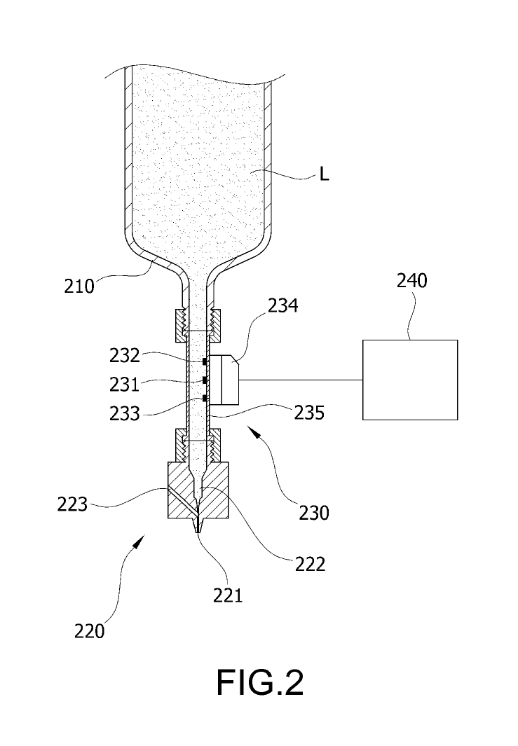

Hereinafter, a flowrate measuring type viscous liquid dispenser and a flowrate measuring type viscous liquid dispensing method according to another embodiment of the present invention will be described with reference to FIG. 2.

Referring to FIG. 2, similarly to the embodiment described with reference to FIG. 1, the flowrate measuring type viscous liquid dispenser according to the present embodiment includes a syringe 210, a pump module 220, a flowrate sensor module 230, and a controller 240. The syringe 210, the flowrate sensor module 230, and the controller 240 are respectively similar to the syringe 110, the flowrate sensor module 130, and the controller 140 of the embodiment of FIG. 1, whereas the pump module 220 has a difference structure from the pump module 120.

The syringe 210 stores a viscous liquid L to be dispensed. A pressure is applied to the syringe 210 so as to easily supply the viscous liquid L stored in the syringe 210 to the pump module 220.

The pump module 220 according to the present embodiment dispenses the viscous liquid L by using a spraying method. The pump module 220 includes a spray path 220, a pneumatic path 223, and a nozzle 221. The spray path 222 is configured such that the viscous liquid L received from the syringe 210 is transferred to the nozzle 221 through the spray path 222. A pressurized air is transferred through the pneumatic path 223 laterally to the spray path 222 in a lateral direction. The pressurized air supplied through the pneumatic path 223 is mixed with the viscous liquid L in the spray path 222 and sprayed through the nozzle 221.

The flowrate sensor module 230 is mounted between the syringe 210 and the pump module 220. The flowrate sensor module 230 measures a flowrate of the viscous liquid L that flows from the syringe 210 to the spray path 222. A measurement pipe 235 of the flowrate sensor module 230 connects the syringe 210 and the spray path 222. As described above, a heater 231 heats the viscous liquid L in the measurement pipe 235, and two temperature sensors 232 and 233 measure a temperature of the viscous liquid L. A calculator 234 receives temperature values of the temperature sensors 232 and 233 to calculate a velocity of the flow and flowrate of the viscous liquid L and transfers the calculated velocity and flowrate to the controller 240.

The controller 240 adjusts an amount of the viscous liquid L dispensed using the pump module 220 by increasing or decreasing a pressure of the air transferred to the pneumatic path 223.

Hereinafter, a flowrate measuring type viscous liquid dispensing method performed using the flowrate measuring type viscous liquid dispenser configured as described above, according to an embodiment of the present invention, will be described.

First, in step (a), the pump module 220 is operated to dispense the viscous liquid L stored in the syringe 210, through the nozzle 221 of the pump module 220. As described above, the viscous liquid L is dispensed by supplying a pressurized air through the pneumatic path 223.

Here, a flowrate of the viscous liquid L transferred from the syringe 210 to the nozzle 221 is measured using the flowrate sensor module 230 in step (b). As described above, step (b) is performed in a following order.

The viscous liquid L is heated using the heater 231 mounted in the measurement pipe 235 in step (b-1). A temperature of the viscous liquid L is measured using the two temperature sensors 232 and 233 in step (b-2). In step (b-3), a velocity of the viscous liquid L may be calculated by considering a difference in temperatures respectively measured by the two temperature sensors 232 and 233 and relative positions of the temperature sensors 232 and 233 with respect to the heater 231.

The controller 240 adjusts the flowrate of the viscous liquid L by receiving the flowrate of the viscous liquid L calculated as in the above-described process and changing a pressure of the air supplied to the pneumatic path 223.

While the present invention has been described with reference to exemplary embodiments, the scope of the present invention is not limited to the embodiments described and illustrated above.

For example, a pump module having other various structures from the structure of the pump module 120 or the pump module 220 illustrated in FIGS. 1 and 2 may be used.

In addition, as the flowrate sensor module 130, 230, various sensors capable of measuring a flowrate of the viscous liquid L other than the above-described structure may also be used.

According to the flowrate measuring type viscous liquid dispenser and dispensing method of the present invention, the flowrate of a viscous liquid to be dispensed is measured in real time to adjust the flowrate of the viscous liquid, thereby dispensing the viscous liquid accurately.

While one or more exemplary embodiments have been described with reference to the figures, it will be understood by those of ordinary skill in the art that various changes in form and details may be made therein without departing from the spirit and scope of the inventive concept as defined by the following claims.

What is claimed is:

1. A flowrate measuring type viscous liquid dispenser comprising:
a syringe for storing a viscous liquid to be dispensed;
a pump module comprising a nozzle and dispensing the viscous liquid through the nozzle by receiving the viscous liquid from the syringe;
a flowrate sensor module mounted in a flow path connecting the nozzle of the pump module and the syringe and configured to measure a flowrate of the viscous liquid; and
a controller configured to receive the flowrate of the viscous liquid measured using the flowrate sensor module and generate a control signal for controlling an operation of the pump module.

2. The flowrate measuring type viscous liquid dispenser of claim 1, wherein the flowrate sensor module comprises:
a measurement pipe, through which the viscous liquid flows, and which has a uniform inner pipe;
a heater mounted in the measurement pipe to heat the viscous liquid;
a plurality of temperature sensors spaced apart from one another and arranged adjacent to the heater in the measurement pipe to measure a temperature of the viscous liquid; and
a calculator for calculating a velocity of the viscous liquid based on a difference in measurement values of the plurality of temperature sensors and transferring the velocity of the viscous liquid to the controller.

3. The flowrate measuring type viscous liquid dispenser of claim 1, wherein the pump module comprises a reservoir that is connected to the nozzle and receives the viscous liquid from the syringe, a valve rod that is liftably inserted into the reservoir, and an updown unit for moving up and down the valve rod according to a signal of the controller,
wherein the flowrate sensor module is mounted between the syringe and the reservoir,
wherein the controller controls an operation of the updown unit.

4. The flowrate measuring type viscous liquid dispenser of claim 1, wherein the pump module comprises a spray path connected to the nozzle so that the viscous liquid of the syringe is transferred to the nozzle through the spray path, and a pneumatic path connected to the spray path so that a pneumatic pressure is transferred through the pneumatic path and the viscous liquid is sprayed through the nozzle,
wherein the flowrate sensor module is mounted between the syringe and the spray path,
wherein the controller controls a pressure of the air transferred to the pneumatic path.

5. A flowrate measuring type viscous liquid dispensing method, the method comprising:
(a) operating a pump module to dispense a viscous liquid stored in a syringe, through a nozzle of the pump module;
(b) measuring a flowrate of the viscous liquid transferred from the syringe to the nozzle, by using a flowrate sensor module mounted in a path connecting the syringe and the nozzle; and
(c) increasing or reducing an amount of the viscous liquid dispensed through the nozzle of the pump module based on the flowrate of the viscous liquid measured in (b).

6. The method of claim 5, wherein step (b) comprises:
(b-1) heating the viscous liquid by using a heater mounted in a measurement pipe between the syringe and the nozzle;
(b-2) measuring a temperature of the viscous liquid by using a plurality of temperature sensors spaced apart from one another and arranged adjacent to the heater; and
(b-3) calculating a velocity of the viscous liquid based on a difference in temperatures measured using the plurality of temperature sensors.

7. The method of claim 5, wherein in (a), the viscous liquid is dispensed through the nozzle by using a spraying method, and in (c), an amount of the viscous liquid to be dispensed is increased or reduced by increasing or reducing a spraying pressure.

8. The method of claim 5, wherein in (a), the viscous liquid is dispensed by moving up and down the valve rod by using an updown unit,
wherein the valve rod is liftably inserted into the reservoir and receives the viscous liquid from the syringe and transfers the viscous liquid to the nozzle,
wherein in (c), an amount of the viscous liquid to be dispensed is increased or reduced by varying at least one of a moving up and down speed, a moving up and down stroke, and the number of times of moving up and down the valve rod by using the updown unit.
